(19) United States
(12) Patent Application Publication
(10) Pub. No.: US 2025/0144785 A1
(43) Pub. Date: May 8, 2025

(54) TOOL CADDY

(71) Applicant: Czarniecki Innovations LLC, Wichita, KS (US)

(72) Inventors: John Czarniecki, Wichita, KS (US); Joshua D. Hixon, Wichita, KS (US); Richard J. Woody, Peck, KS (US); Sheldon J.K. Oetken, Wichita, KS (US)

(21) Appl. No.: 18/936,684

(22) Filed: Nov. 4, 2024

Related U.S. Application Data
(60) Provisional application No. 63/562,601, filed on Mar. 7, 2024.
(60) Provisional application No. 63/562,596, filed on Mar. 7, 2024.
(60) Provisional application No. 63/596,077, filed on Nov. 3, 2023.

(51) Int. Cl. B25H 3/06; B25H 3/00; B25H 3/02; B62B 3/00

(52) U.S. Cl. CPC B25H 3/06; B25H 3/003; B25H 3/021; B62B 3/005

(57) ABSTRACT

A tool caddy for organizing a plurality of tools on a cart includes a caddy body arranged for being supported on a utility cart. The caddy body has a cart-top portion above the cart and an overhang portion that overhangs the cart. A bin is supported on the overhang portion of the caddy body. Additionally, the caddy body supports a plurality of tool organizers that each have a plurality of tool holes for holding the tools. The caddy body defines a lower storage compartment for storing equipment below the tool organizers. One tool organizer is a moveable organizer that is moveable between a closed position in which the moveable organizer covers the top of the lower storage compartment and an open position in which the moveable organizer uncovers the top of the lower storage compartment. The tool caddy is releasably fastened to the cart with a quick-connect fastening system.

### CROSS-REFERENCE TO RELATED APPLICATIONS

This application claims the benefit of U.S. Provisional Patent Application Ser. No. 63/596,077, filed on Nov. 3, 2023, U.S. Provisional Patent Application Ser. No. 63/562,601, filed on Mar. 7, 2024, and U.S. Provisional Patent Application Ser. No. 63/562,596, filed on Mar. 7, 2024, the entire contents of which are hereby incorporated by reference.

### FIELD

The present disclosure generally relates to a tool caddy for storing and organizing tools on an industrial cart.

### BACKGROUND

There are many well-known tool storage and organization devices, and in many instances, the devices are configured for transporting tools. For example, smaller tool storage and organization devices such as tool bags and tool belts may be wearable by users for transporting the tools. These smaller tool storage devices may not have the capacity for storing many tools. Larger tool storage and organization devices such as industrial tool boxes and chests may be used to store an abundance of tools, but these devices are bulky and difficult to maneuver around jobsites. Moreover, larger tool storage devices are prone to clutter and difficult to access as tools are often haphazardly concealed in large compartments of the device.

### BRIEF SUMMARY

In one aspect, a tool caddy for organizing a plurality of tools on a cart comprises a caddy body comprising a cart-top portion and an overhang portion. The caddy body is configured to be supported on the cart such that the cart-top portion is above the cart and the overhang portion overhangs the cart. A plurality of tool organizers are supported on the caddy body. Each tool organizer comprises a plate defining a plurality of tool holes configured to receive portions of tools for holding the tools on the respective plate. A bin is supported on the overhang portion of the caddy body.

In another aspect, a tool caddy for organizing a plurality of tools on a cart comprises a caddy body configured to be supported on the cart. The caddy body has a bottom, a top, and a height extending from the bottom to the top. The caddy body further has an inner end an outer end spaced apart along a longitudinal axis. The caddy body defines a lower storage compartment having a top. A plurality of tool organizers are supported on the caddy body. Each tool organizer comprises a plate defining a plurality of tool holes configured to receive portions of tools for holding the tools on the respective plate. One of the plurality of tool organizers comprises a moveable organizer. The moveable organizer is operatively connected to the caddy body such that the moveable organizer is movable in relation to the caddy body between a closed position in which the moveable organizer covers the top of the lower storage compartment and an open position in which the moveable organizer uncovers the top of the lower storage compartment.

In another aspect, a tool caddy for organizing a plurality of tools on a cart comprises a caddy body comprising a cart-top portion and an overhang portion. The caddy body is configured to be supported on the cart such that the cart-top portion is above the cart and the overhang portion overhangs the cart. A plurality of tool organizers are supported on the caddy body. Each tool organizer comprises a plate defining a plurality of tool holes configured to receive portions of tools for holding the tools on the respective plate. A lower storage compartment is configured to store equipment below the plurality of tool organizers. The tools held by the plurality of tool organizers do not interfere with the equipment stored in the lower storage compartment.

In another aspect, a tool caddy for organizing a plurality of tools on a cart comprises a caddy body configured to be supported on the cart. A plurality of tool organizers are supported on the caddy body. Each tool organizer comprises a plate defining a plurality of tool holes configured to receive portions of tools for holding the tools on the respective plate. A quick-connect fastening system is configured to releasably fasten the tool caddy to the cart without tightening threaded fasteners.

In another aspect, a tool cart for organizing and storing a plurality of tools comprises a cart frame, a tool caddy removably mounted to the cart frame, a cart-mountable drawer assembly attachment removably mounted to the cart frame, and a cart-mountable story pole attachment removably mounted to the cart frame.

In another aspect, a cart-mountable drawer assembly attachment for a cart comprises a drawer case comprising a top portion comprising one or more mounting reinforcements and one or more alignment holes for mounting the cart-mountable drawer assembly to the cart. A storage assembly is operably mounted to the drawer case.

In another aspect, a cart-mountable story pole attachment for a cart comprises an extension pole, a cart mount, and a magnetic attachment.

Other objects and features will be in part apparent and in part pointed out hereinafter.

### BRIEF DESCRIPTION OF THE DRAWINGS

FIG. 1 is a perspective of a tool caddy organizing a plurality of tools on a cart.

FIG. 2 is a perspective of the tool caddy of FIG. 1 organizing tools.

FIG. 3 is another perspective of the tool caddy of FIG. 1 organizing tools.

FIG. 4 is a perspective of a tool caddy without any tools.

FIG. 5 is another perspective of the tool caddy without any tools.

FIG. 6 is a top plan view of the tool caddy.

FIG. 7 is an end elevation of the tool caddy.

FIG. 8 is a side elevation of the tool caddy.

FIG. 9 is a side elevation of the tool caddy opposite the view in FIG. 8.

FIG. 10 is an exploded perspective of the tool caddy.

FIG. 11 is a cross-section taken in the plane of line 11-11 of FIG. 6.

FIG. 11A is a cross-section similar to FIG. 11 but showing a slide-out organizer in an open position.

FIG. 12 is a cross-section taken in the plane of line 12-12 of FIG. 6, superimposed on a schematic illustration of an upper tray of a utility cart to indicate how the tool caddy attaches to the utility cart.

FIG. 13 is an elevation of another embodiment of a tool caddy superimposed on a schematic illustration of an upper tray of a utility cart to indicate how the tool caddy attaches to the utility cart.

FIG. 14 is an exploded perspective of the tool caddy of FIG. 13.

FIG. 15 is a top plan view of a moveable organizer insert of the tool caddy of FIG. 14.

FIG. 16 is a top plan view of an upper organizer insert of the tool caddy of FIG. 14.

FIG. 17 is a top plan view of a drill/driver organizer of the tool caddy of FIG. 14.

FIG. 18 is a top plan view of a removable base for the tool caddy of FIG. 13.

FIG. 19 is an elevation of the removable base.

FIG. 20 is an elevation of the removable base.

FIG. 21 is an elevation of the removable base opposite the view in FIG. 19.

FIG. 22 is a bottom plan view of the removable base.

FIG. 23 is a perspective of a chassis of the tool caddy of FIG. 13.

FIG. 24 is an elevation of the tool caddy connected to the removable base.

FIG. 24A is an enlarged view of Detail A from FIG. 24.

FIG. 24B is an enlarged view of Detail B from FIG. 24.

FIG. 25 is another perspective of the tool caddy of FIG. 13 showing the caddy in the process of being attached to the base.

FIG. 26 is a perspective of a tool cart with attachments.

FIG. 27 is an exploded perspective of a cart-mountable drawer assembly attachment.

FIG. 28 is a perspective of an embodiment of the cart-mountable drawer assembly attachment of FIG. 27 mounted on a cart.

FIG. 29 is an exploded perspective of a cart-mountable story pole attachment.

FIG. 30 is a perspective of an embodiment of the cart-mountable story pole attachment of FIG. 29 in a retracted position on a cart.

FIG. 31 is a perspective of an embodiment of the cart-mountable story pole attachment of FIG. 29 in an extended position on a cart.

FIG. 32 is a perspective of another embodiment of a tool caddy.

FIG. 32A is an enlarged perspective of a portion of the tool caddy of FIG. 32.

Corresponding reference characters indicate corresponding parts throughout the drawings.

### DETAILED DESCRIPTION

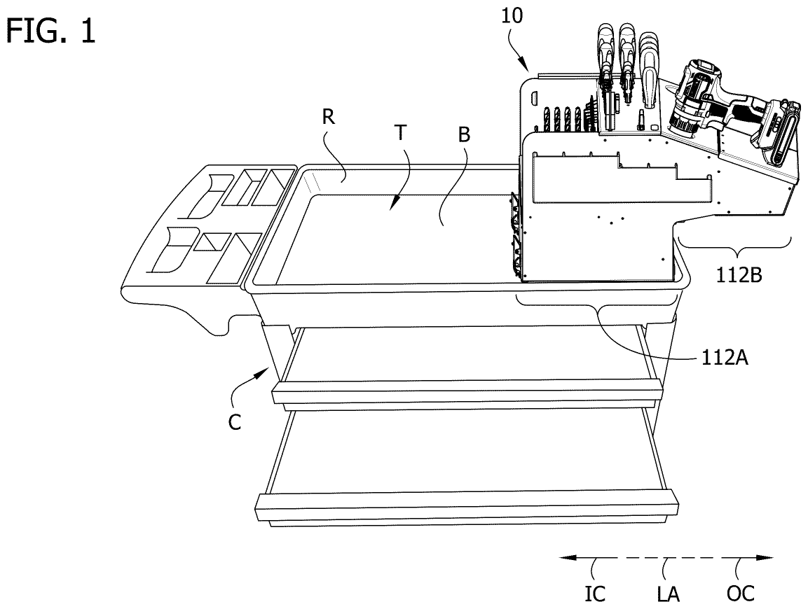

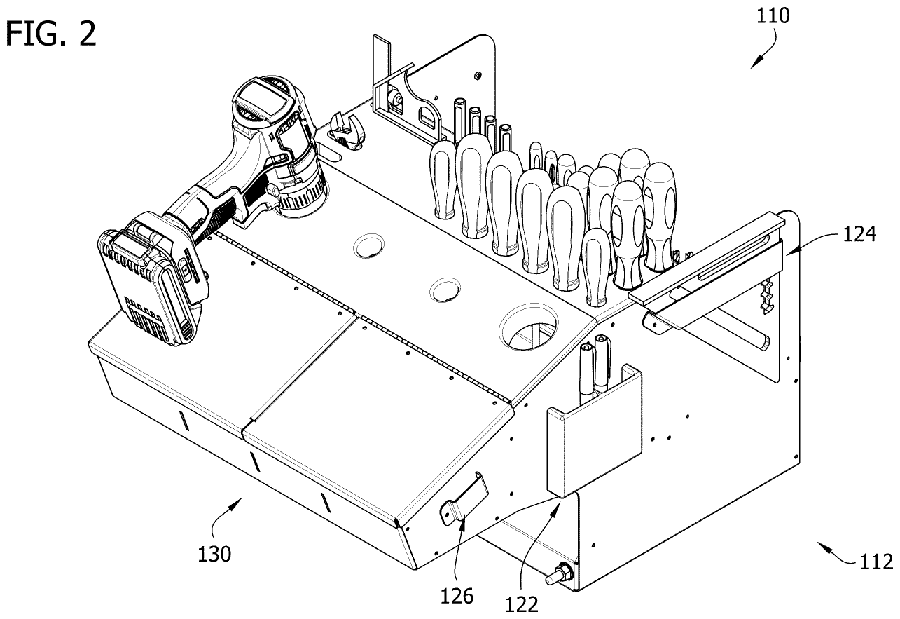

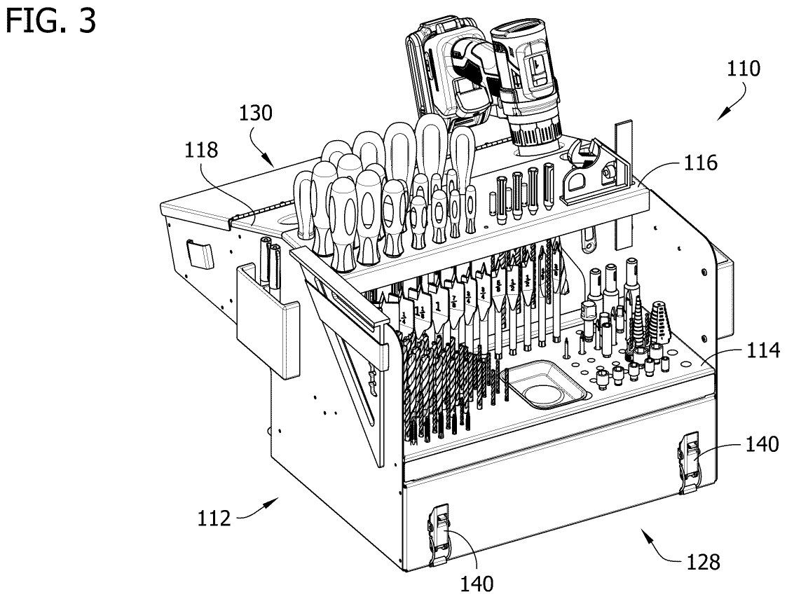

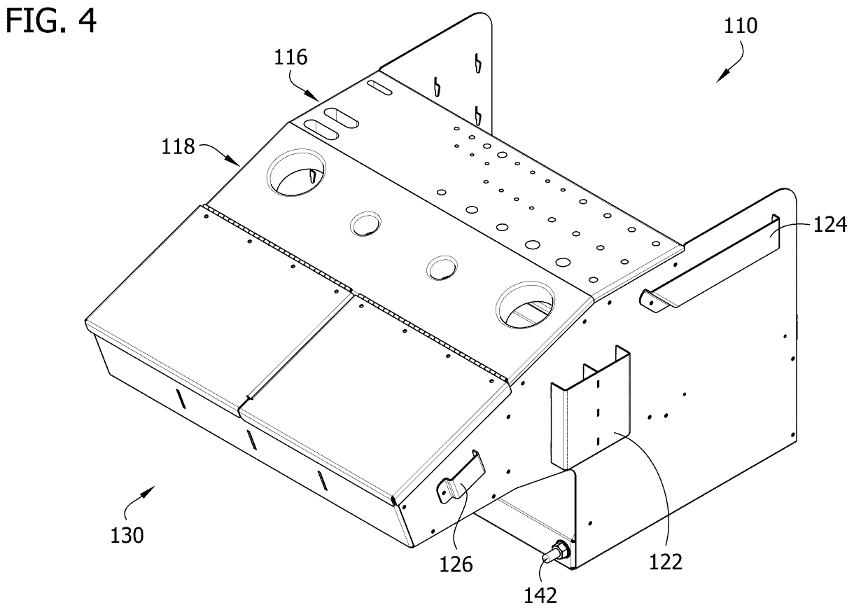

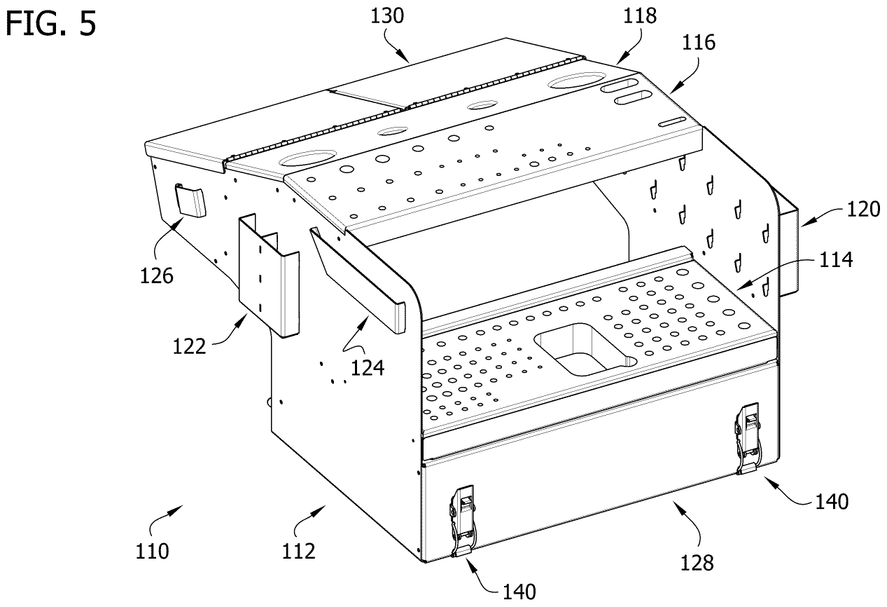

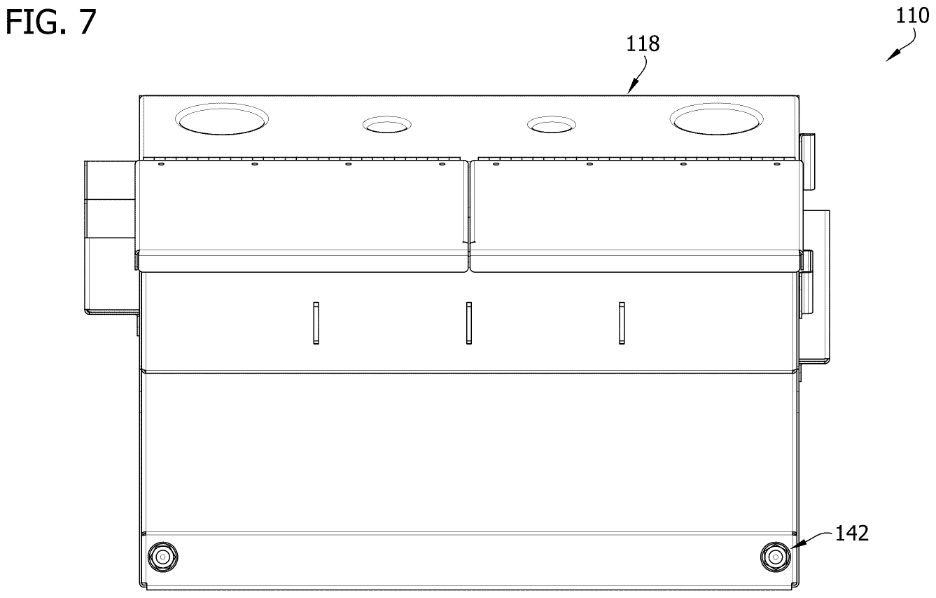

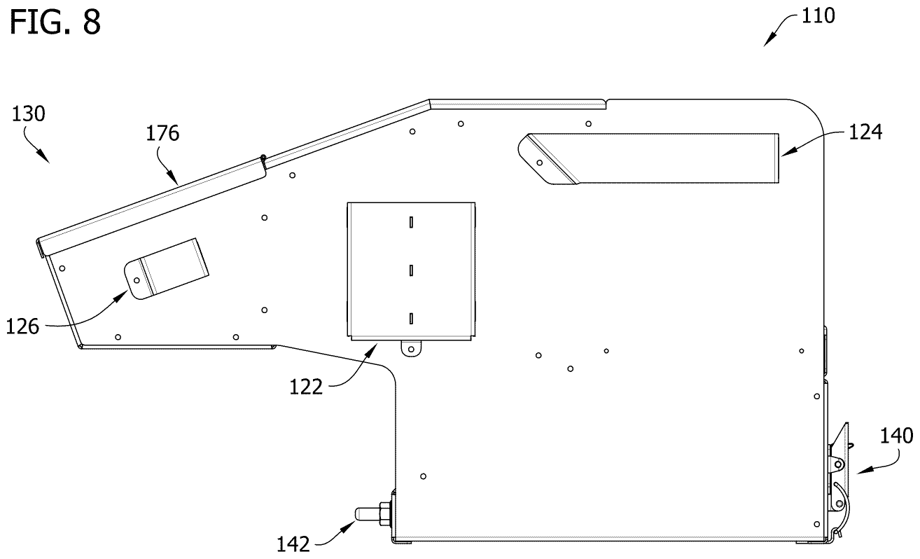

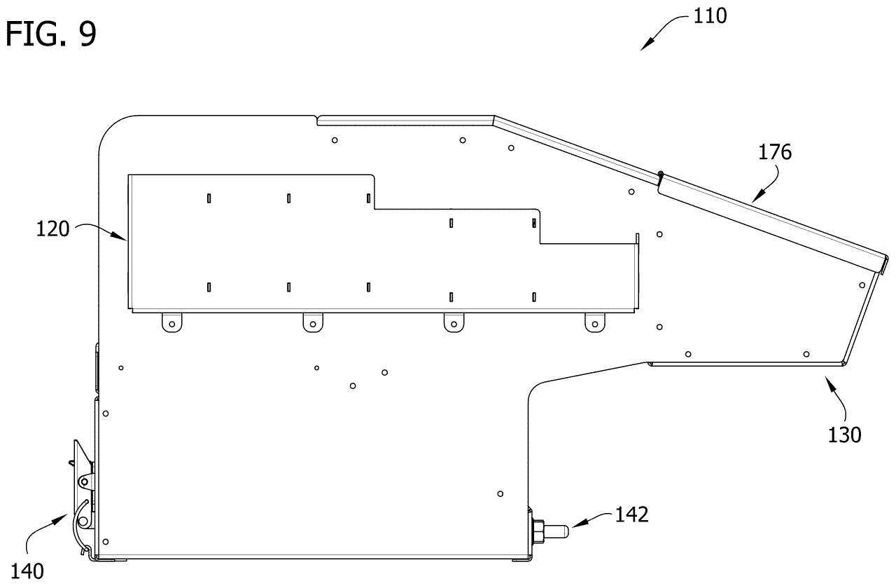

Referring to FIGS. 1-12, an exemplary embodiment of a tool caddy for a utility cart is generally indicated at reference number 10. In FIG. 1 an example utility cart C is illustrated. As shown, the utility cart C comprises an upper tray T including a tray bottom B and a rim R standing up from the tray bottom. The tool caddy 10 of the present disclosure is supported on the tray T of the utility cart C. The tool caddy 10 is configured for use with various types of utility carts having upper trays. Accordingly, it is to be understood that the features of the cart C shown in FIG. 1 are not a limiting aspect of the disclosure.

The caddy 110 broadly comprises a caddy body 112 that supports one or more tool storage and organization features. The one or more tool storage and organization features described herein are used for storing and organizing a plurality of different tool types, as well as other construction equipment such as consumables and work materials. In an exemplary embodiment, the tool storage and organization features can include one or more tool organizers 114, 116, 118, one or more rigid tool pockets 120, 122, one or more tool hangers 124, 126, an openable storage compartment 128, and a bin 130. It will be appreciated that other configurations of tool storage and organization features besides what is shown in the drawings can be used without departing from the scope of the disclosure. In addition to the tool storage and organization features, the caddy 10 comprises a quick connect fastening system configured for releasably fastening the tool caddy to the cart C. Advantageously, this enables the tool caddy 10 to be secured to the cart C without requiring any tightening of threaded fasteners. However, it is contemplated that the tool caddy 10 may also be secured to the cart C via the tightening of threaded fasteners.

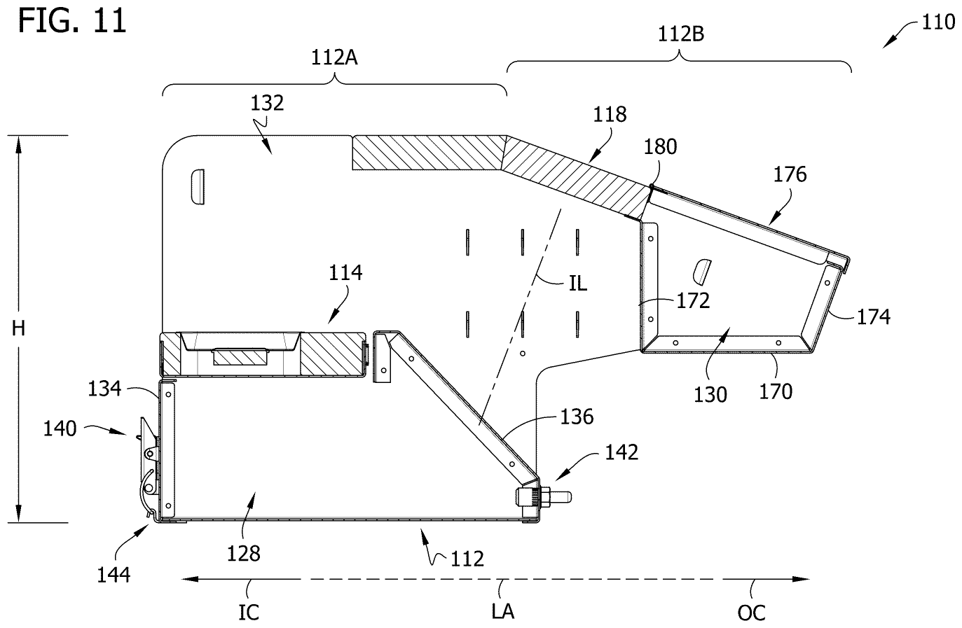

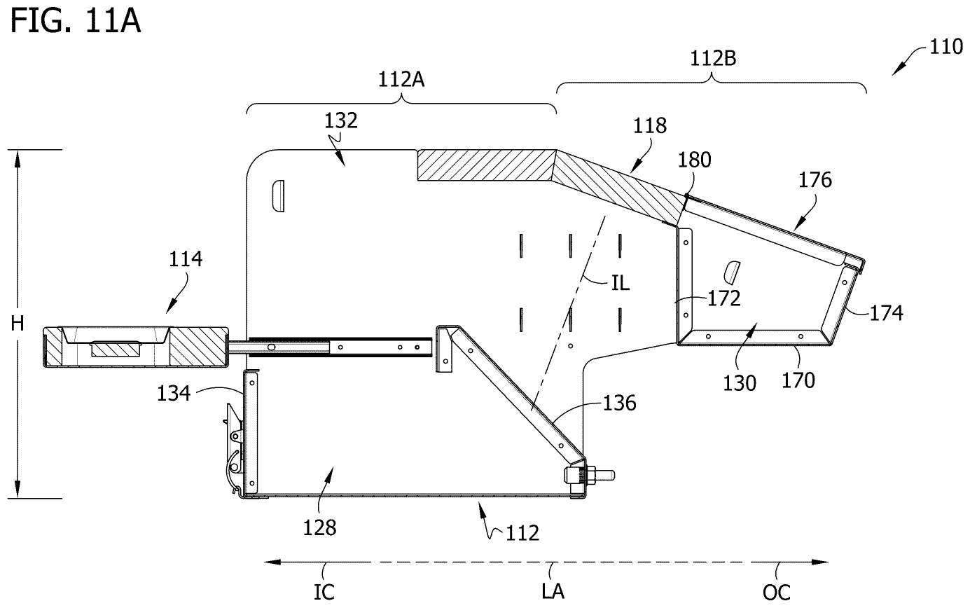

The caddy body 112 has a bottom, a top, and a height H extending from the bottom to the top of the caddy body (FIG. 11). The caddy body 112 also has a longitudinal axis LA and an inner end and an outer end spaced apart along the longitudinal axis. The inner end is spaced apart from outer end in an inboard-of-cart longitudinal direction IC, whereas the outer end is conversely spaced apart from the inner end in an outboard-of-cart longitudinal direction OC. As shown in FIG. 1, the caddy body 112 is configured to be mounted on the cart C such that the inner end (the longitudinal end in the inboard-of-cart direction IC) is nearer the center of the cart tray T (inboard in relation to the cart) and the outer end (the longitudinal end in the outboard-of-cart direction OC) is further from the center of the cart tray (outboard in relation to the cart). The caddy body 112 generally encompasses two longitudinal portions 112A, 112B of the tool caddy 110. The first longitudinal portion 112A is an inner “cart-top” portion configured to be supported on the cart C so that the cart-top portion is directly atop and over the cart. The second longitudinal portion 112B is an overhang portion configured to project outward past the rim R of the cart tray T such that the overhang portion overhangs the cart C. In other words, the overhang portion 112B protrudes beyond the perimeter of the cart in cantilevered fashion. The overhang portion 112B is not directly above the cart C but rather is located outboard of the perimeter of the cart. In the illustrated embodiment, the upper end of the overhang portion 112B is angled to slope downward in the outboard-of-cart direction OC. The caddy body 112, including overhang portion 112B, is sized and arranged such that the tool caddy 110 maintains a suitable weight distribution on the cart C. The overhang portion 112B does not cause the cart C to tip over or cause the loaded tool caddy 110 to tip over on the cart. Further, the quick connect fastening system of the caddy 110 secures caddy to the cart C to inhibit the caddy from falling off of the cart.

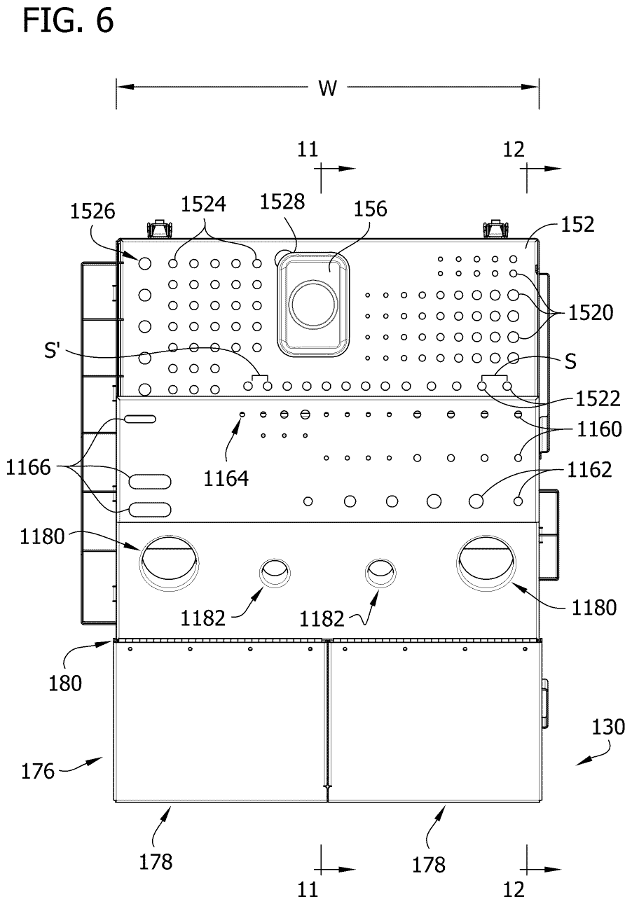

In the illustrated embodiment, the caddy body 112 comprises a U-shaped chassis 132. In an exemplary embodiment, the chassis 132 can be formed from sheet metal. However, the chassis 132 may be shaped differently to support the features described herein and may be formed from other suitable materials without departing from the scope of the present disclosure. The illustrated chassis 132 comprises a bottom wall defining the bottom end of the caddy body and opposite first and second side walls extending up from the bottom walls. The side walls are spaced apart along a width W (FIG. 6) of the chassis 132. The side walls define various mounting features (e.g., fastener holes and hanging slots) for securing other components to the chassis 132.

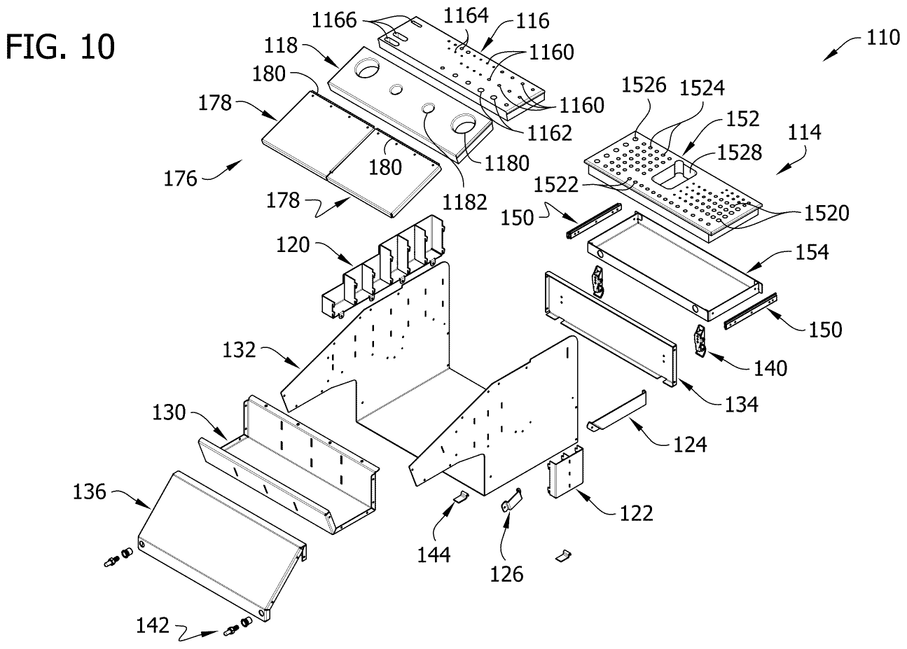

The illustrated caddy body 112 comprises inner and outer storage compartment end panels 134, 136 fixed to the chassis 132 between the side walls. Each of the end panels 134, 136 is located along the cart-top portion 112A of the caddy body 112 (FIGS. 10-11). Each end panel 134, 136 extends height-wise from the bottom end of the caddy body 112 to an enclosed bottom end of one of the tool organizers 114 (described in further detail below). Collectively, the inner end panel 134, the outer end panel 136, and the tool organizer 114 define the openable lower storage compartment 128. The illustrated inner end panel 134 extends in a vertical plane parallel to the caddy body height H. By contrast, a majority of the outer end panel 136 is angled to slope downward in the outboard-of-cart direction OC. As explained more fully below, the sloping outer end panel 136 provides additional space for elongate distal features of tools held by the tool organizers 116, 118.

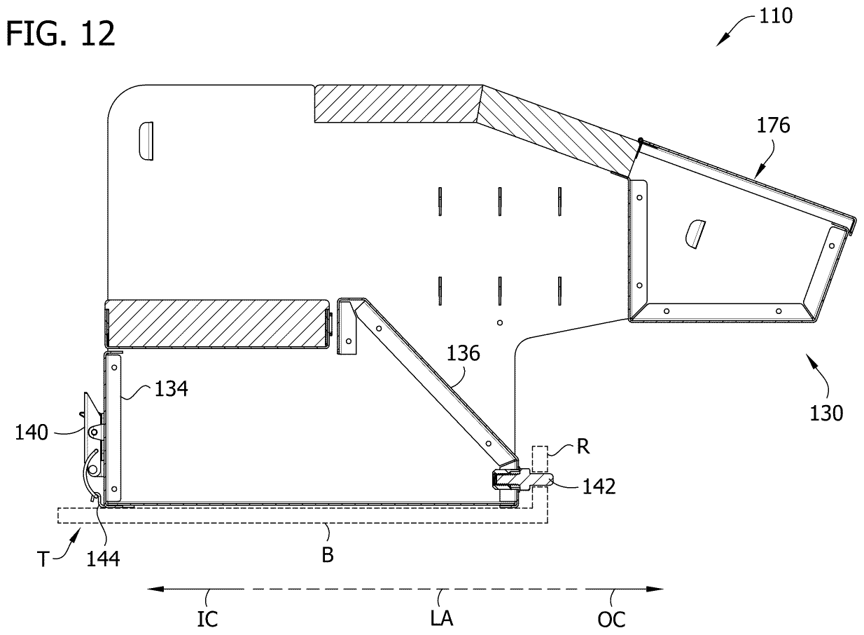

Still referring to FIGS. 1-12, the quick connect fastening system comprises fastening components 140, 142 mounted on the inner and outer panels 134, 136, respectively. Particularly, one or more studs 142 are mounted on the lower portion of the outer end panel 136, and one or more releasable latches 140 are mounted on the inner end panel 134. In the illustrated embodiment, there are two studs 142 mounted on the outer end panel 136 and two toggle latches 140 mounted on the inner end panel 134. The quick connect fastening system further comprises a catch 144 for each latch 140. The catches 144 are not mounted on the caddy body 112. Instead, the catches 144 are separately secured to the bottom B of a cart tray T. In addition, use of the quick connect fastening system requires forming holes in the rim R of the off-the-shelf cart tray T for reception of the studs 142 therein. FIG. 12 shows the quick connect fastening system in use. As can be seen, the studs 142 are inserted into the holes formed in the rim R of the cart tray T. The toggle latches 140 are latched with the catches 144. To remove the tool caddy 110 from the cart tray T, the user simply unlatches the toggle latches 140, tilts the tool caddy to release the studs 142 from the rim R, slides the tool caddy in the inboard-of-cart longitudinal direction IC such that the studs 142 clear the holes of the rim, and then lifts the tool caddy out of the tray T. Conversely, to install a tool caddy 110 in the cart (after securing the catches 144 and forming the stud holes in the rim R at the proper locations), a user simply manipulates the tool caddy to insert the studs 142 into the stud holes, rests the bottom of the caddy body 112 on the tray bottom B, and then latches the toggle latches 140 to the catches 144.

In the illustrated embodiment, the tool caddy 110 comprises three tool organizers 114, 116, 118 between the side walls of the chassis 132. Other tool caddies could have other numbers of tool organizers without departing from the scope of the disclosure. Each tool organizer comprises a plate defining a plurality of tool holes configured to receive portions of tools for holding tools on the respective plate. In general, the tool holes are configured to receive distal portions of respective tools such that proximal portions of tools extend upward from the respective plate. In some cases, the tools protrude downward past the bottom of the respective plate. In other cases, the tool organizer may have an enclosed bottom that prevents some or all of the tools from protruding beyond the bottom of the plate. The plate of each tool organizer can be made from any suitable material. In an exemplary embodiment, each tool organizer 114, 116, 118 is formed from plastic plate stock machined to make the tool holes. In another exemplary embodiment, the plate of each tool organizer 114, 116, 118 is formed from sheet metal stock machined to make the tool holes. Suitably, the plurality of tool organizers 114, 116, 118 are mounted on the caddy body 112 and spaced apart along the longitudinal axis LA. At least two of the tool organizers 114, 116 are located at different levels along the height H of the caddy body 112. In certain embodiments, at least one of the tool organizers 118 is mounted on the caddy body 112 at a sloping angle. Other tool organizers 114, 116 are mounted on the caddy body 122 horizontally.

In an exemplary embodiment, the lowest and innermost tool organizer 114 is a moveable organizer. The moveable organizer 114 is operably connected to the caddy body 112 such that it is moveable in relation to the caddy body between a closed position in which the moveable organizer covers the top of the lower storage compartment 128 and an open position in which the moveable organizer uncovers the top of the lower storage compartment. To ensure there is no interference between the tools held by the moveable organizer 114 and the inner end panel 134 during opening and closing, the bottom of the moveable organizer 114 is closed. In the illustrated embodiment, this is accomplished by forming the moveable organizer 114 in two pieces 152, 154 (FIG. 10). Firstly, the moveable organizer 114 comprises a tool hole plate 152 in which are formed a plurality of tool holes 1520, 1522, 1524, and 1526. Secondly, the moveable organizer 114 comprises a closed-bottom tray 154 for receiving the tool hole plate 152 therein. The closed-bottom tray 154 defines the enclosed bottom of the moveable organizer 114. During use, tools received in the tool openings 1520, 1522, 1524, 1526 are supported on the closed-bottom tray 152 and do not protrude past the enclosed bottom of the moveable organizer 114.

For purposes of completeness, an example of a moveable organizer in accordance with the present disclosure will now be described, however it will be apparent to one of ordinary skill in the art, that other moveable organizers may be used without departing from the scope of the present disclosure.

In the illustrated embodiment, the moveable organizer 114 comprises a slide-out organizer. At least one drawer slide 150 operably connects the slide-out organizer to the caddy body 112 such that slide-out organizer is slidable in relation to the caddy body between the closed position (FIG. 11) in which the slide-out organizer covers the top of the lower storage compartment 128 and the open position (FIG. 11A) in which the slide-out organizer uncovers the top of the lower storage compartment. Furthermore, in the illustrated embodiment, first and second drawer slides 150 are mounted on the opposing side walls of the chassis 132. The drawer slides 150 mount the slide-out organizer 114 so that the outer end is immediately adjacent the upper end of the outer end panel 136 when the slide-out organizer is in the closed position. In addition, the drawer slides 150 mount the slide-out organizer immediately above the inner end panel 134. Hence, the slide-out organizer 150 must slide across the top of the inner end panel 134 when moving between the closed and open positions.

It is contemplated that in an exemplary embodiment (not shown), the moveable organizer 114 may include at least one linkage system comprising a plurality of links and at least one joint to facilitate movement of the moveable organizer between the open and closed positions. For example, the moveable organizer 114 may be mounted to the caddy body 112 via first and second linkage systems attached to the opposing sidewalls of the chassis 132, such that each linkage system has a first end portion attached to the sidewall and a second end portion attached to moveable organizer. With the linkage system, the height of the moveable organizer fluctuates between a height range defined by the number of links and joints of the linkage system, as the moveable organizer is moved between the open and closed positions. For example, the moveable organizer 114 achieves its lowest height in the closed position and achieves its highest height in the open position. The linkage systems are configured to the caddy body 112 and moveable organizer 114 such that as the moveable organizer 114 moves between the open and closed positions, the moveable organizer and tools held therein do not interfere with other components of the caddy 110 such as tool organizer 116. Linkage systems may also be used on other components of the tool caddy 110, wherein movement of the components is desired.

In the illustrated embodiment the tool hole plate 152 comprises tool holes 1520, 1522, 1524, and 1526 that are predominantly shaped and arranged to hold different types of bits for drills and drivers. However, the tool holes 1520, 1522, 1524 and 1526 may hold other tooling as well. The tool holes 1520 are circular brad point drill bit openings having inner diameters in a range of sizes to accommodate the standard sizes of round-shaft brad point drill bits from ⅛″ to ⅜″. Certain embodiments may also include tap bit holes having inner diameters in a range of sizes to accommodate tap bits from 6-32 to 14-20. The tool holes 1522 are spade bit openings for receiving standard sizes of hex-chuck spade drill bits from ⅜″ to 1 1/34″. Other ranges of bit sizes are also possible without departing from the scope of the disclosure. The spade bit openings 1522 have progressively increasing spacing S along the tool plate 152 to accommodate the standard spade bit sizes. Tool holes 1524 are driver bit openings that are evenly spaced and sized to receive the hex-chuck ends of driver bits. Tool holes 1526 are large bit openings for receiving tooling bits with larger diameters such as step drill bits.

In the illustrated embodiment, the tool hole plate 152 further defines a pan opening 1528 configured to receive a magnetic pan 156 therein. Those skilled in the art will recognize that the magnetic pan is useful for holding loose ferromagnetic objects like miscellaneous fasteners or other hardware.

The tool organizer 116 is an upper tool organizer. The inventors envision that the upper tool organizer 116 will be predominantly used for holding tools that are most effectively and safely stored with distal end portions of the tools extending downward into the tool caddy 110 and proximal end portions protruding above the tool caddy for quick and easy access of the tools. The upper tool organizer 116 stores the tools in its respective tool openings 1160,1162, 1164, 1166. In the illustrated embodiment, each tool opening 1160, 1162, 1164, 1166 of the upper tool organizer 116 is a through opening extending from the top through the bottom of the upper tool organizer. Hence, in use, distal end portions of tools inserted in the tool openings 1160, 1162, 1164, 1166 hang downward below the bottom of the upper tool organizer 116. As shown in FIG. 11, at least a portion of the upper tool organizer is located above the sloping outer end panel 136. The slope of the outer end panel 13 provides progressively greater vertical clearance between the upper tool organizer 116 in the outboard-of-cart direction OC.

In the illustrated embodiment, the upper tool organizer 116 includes first and second inner rows of tool openings 1160 adjacent the inner end of the upper tool organizer and an outer row of tool openings 1162 adjacent the outer end of the upper tool organizer. In the illustrated embodiment, the tool openings 1160, 1162 are circular openings configured to receive distal portions of hand drivers (e.g., handheld screwdrivers) therein. Suitably, the tool openings 1162 in the outer row are, on average, larger than the tool openings 1160 of the inner rows. This aligns the larger tool opening 1162 longitudinally with an area above the sloping end panel 136 where there is greater vertical clearance so that larger tools with longer distal portions will be naturally placed into the larger holes where there is sufficient vertical clearance.

In one embodiment, the upper tool organizer 116 further comprises tool openings 1164 and 1166. Tool openings 1164 comprise circular openings that are configured for receiving distal portions of hand drivers (similar to those of 1160 and 1162), but the diameters of the tool openings 1164 are sized and arranged to accommodate correspondingly sized hand tools. Tool openings 1166 comprise slots configured to receive proximal or distal portions of non-circular tooling such as wrenches and measurement tools.

In the illustrated embodiment, each of the moveable and upper tool organizers 114, 116 are mounted on the cart-top portion 112A of the caddy body 112. A third, drill/driver organizer 118 is mounted on the overhang portion 112B of the caddy body 112. The tool holes 1180, 1182 of the drill/driver organizer 118 are sized and arranged for receiving chuck portions of cordless drills or drivers. The drill/driver organizer 118 extends in a plane sloping downward in the outboard-of-cart direction OC. The illustrated drill/driver organizer 118 comprises first and second drill holes 1180 that are sized and arranged for receiving chuck portions of cordless drills and first and second driver holes 1182 sized and arranged for receiving chuck portions of cordless drivers. The driver holes 1182 are smaller than the drill holes 1180, and in the illustrated embodiment, located inboard widthwise of the driver holes. As shown in FIG. 11, an imaginary line IL orthogonal to the drill/driver organizer 118 extending downward from the longitudinal midpoint intersects the lower half of the sloping end panel 136. This arrangement provides ample vertical clearance for inserting drills and drivers into the holes 1180, 1182 while drill or driver bits remain attached to the chucks.

In the illustrated embodiment, in addition to the drill/driver organizer 118, the overhang portion 112B of the caddy body 112 also holds a general purpose bin 130 for additional storage of loose articles. The bin 130 is mounted between the opposing side walls of the caddy body chassis 132. The illustrated bin 130 comprises a sheet metal panel formed into a generally U-shaped body having a bottom section 170, an inner section 172 and an outer section 174. The outer section 174 forms the outer end of the tool caddy 110, which is suspended in cantilevered fashion from the cart-top portion 112A. In certain embodiments (not shown) the bin 130 further comprises dividers extending across the U-shaped body, for compartmentalizing components stored within the bin. The illustrated tool caddy 110 further comprises a lid 176. The illustrated lid 176 comprises first and second independently openable lid members 178 each connected to the outer end of the drill/driver organizer 118 by a respective hinge 180. In the drawings, the lid 176 is closed. But it will be understood that the lid 176 can open partially or fully by rotating one or both of the lid members 178 upward about the respective hinge 180. Opening one or both lid members 178 provides access to the bin 130.

Accordingly, the bin lid 176 and the drill/driver organizer 118 are supported on the overhang portion 112B of the caddy body 112 so that the drill/driver organizer is between the lid and the cart-top portion 112A of the caddy body along the longitudinal axis LA. The lid 176 and the drill/driver organizer 118 are generally coplanar, extending in a plane sloping downward in the outboard-of-cart direction OC. The lid 176 is configured to underlie grip portions and/or battery portions of cordless drills and/or drivers received in the tool holes 1180, 1182 of the drill/driver organizer 118. For typical drill/driver models, the lid 176 is situated to engage a front end of the battery and support the grip portions of the drills/drivers by such engagement. Accordingly, it can be seen that the overhang portion 112B is configured to provide stable support for drills and drivers retained in the organizer 118 and still also provide a bin 130 for additional storage outside of the footprint of the cart C on which the caddy 110 is supported. The use of two individually openable lid members 178 allows for access to one side of the bin 130 while a drill and/or driver is supported on the opposite lid member.

In an exemplary embodiment, the side walls of the chassis 132 are configured to support one or more rigid tool pockets 120,122 and one or more tool hangers 124, 126 mounted thereto. In one example, the side walls of the chassis 132 comprise slots for receiving hanging tabs of the tool pockets 120, 122 and tool hangers 124, 126. The hanging tabs are pressed into the slots such that the tool pockets 120, 122 and tool hangers 124 are removably secured to the chassis 132. In another example, the tool pockets 120, 122 and tool hangers 124, 126 can be bonded to the sidewalls of the chassis by bonding techniques such as welding. It is apparent to one skilled in the art, that other mounting techniques may be used to mount the tool pockets 120, 122 and tool hangers 124, 126 to the sidewalls of the chassis 132 without departing from the scope of the present disclosure. Each of the tool pockets 120, 122 and tool hangers 124, 126 is configured to hold one or more of tools on the exterior of the caddy body 112. The tool pockets 120, 122 are configured to hold the tools such that the tools do not protrude past closed bottoms of the tool pockets. In the illustrated embodiment, the tool pockets 120, 122 further comprise sectioning walls that define compartments for subdividing compartments for individual tools. The tool hangers 124, 126 each comprise an open top and bottom for receiving tools such that at least a portion of the tools protrudes past the open bottom. Both of the tool pockets 120, 122 and tool hangers 124, 126 may be shaped and arranged in various configurations to hold various tool types.

Advantageously, the tool caddy 110 of the present disclosure is used to safely and efficiently store, organize, and transport a plurality of tools. For example, the caddy 110 is optimally designed to limit a user's exposure to ergonomic risk factors associated with handling and transporting tooling and equipment. The quick-connect fastening system enables the caddy 110 to be secured on a cart C for safely transporting the tools stored on the caddy. Additionally, with this feature the caddy 110 is easily removable and securable to carts and surfaces of various heights to accommodate variability in anthropometric measurements of users. This feature of the caddy 110 is also particularly advantageous for locking up the tools at the end of the day, as the entire cart C with the caddy 110 may be wheeled to a secured location or the caddy alone may be easily removed from the cart to the secured location. Furthermore, the compact design and moveable components of the caddy 110 reduce a user's exposure to hazards associated with reaching for tools, as the caddy 110 may be placed and secured directly on a workstation for case-of-access for the user and moveable tool organizers may be moved (e.g., slid-out or pulled-out) to a position where the tools held by the moveable tool organizers are closer to the user.

Another benefit provided by the tool caddy 110 of the present disclosure is that the caddy includes numerous organized tool storage compartments including the tool organizers 114, 116, 118, tool pockets 120, 122, tool hangers 124, 126, lower storage compartment 128, and bin 130 with lid 176 for storing tools in an organized manner. The caddy 110 provides dedicated storage spaces for a variety of tool types such as drills, drivers, drill bits, and other miscellaneous hardware and tools to eliminate clutter and time spent searching for tools. Moreover, the caddy 110 is designed to store the tools in a ready-to-use configuration, so that the tools are readily available to users. The caddy 110 is also designed to optimize space on a cart C, when the caddy is secured to the cart. Accordingly, the caddy 110 occupies only a portion of the cart C so that the cart still has an ample amount of functional space for other objects. Additionally, the overhanging bin 130 provides storage space outside of the footprint of the cart C altogether, so that more tools and equipment may be stored on the caddy 110 without taking up functional space on the cart.

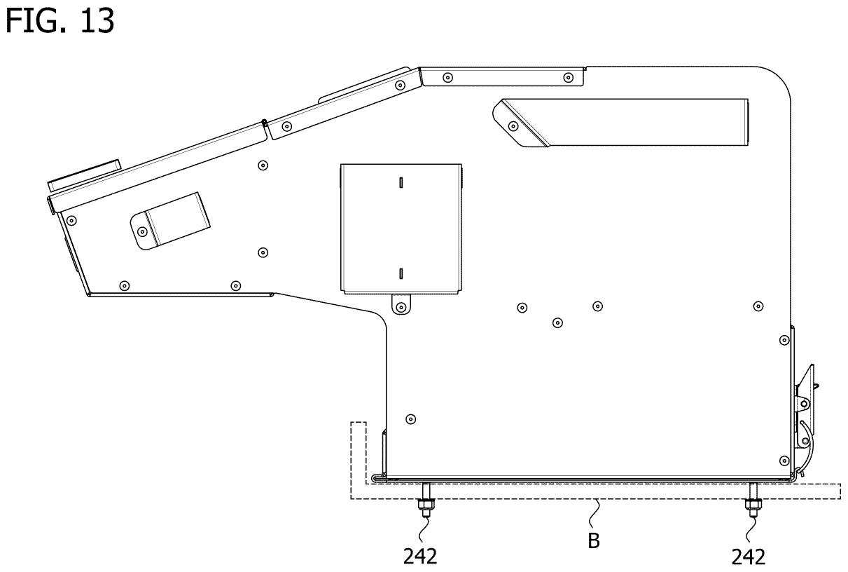

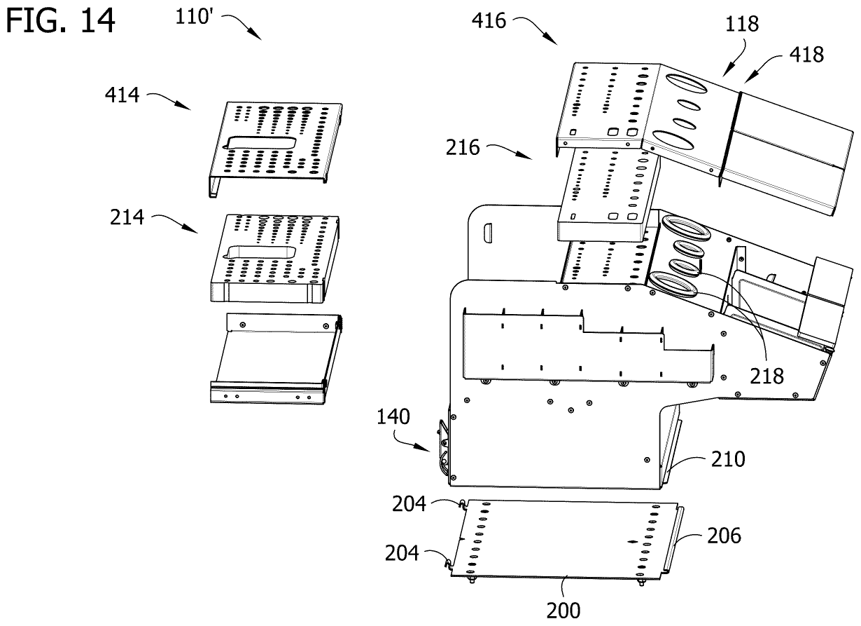

Referring now to FIGS. 13-14, another embodiment of a tool caddy according to the present disclosure is generally indicated at reference number 110′. The tool caddy 110′ of FIGS. 13-14 has many features in common with the tool caddy 110 of FIGS. 1-12. Thus for case of description, where similar, analogous, or identical parts are used, identical reference numerals are employed. Accordingly, unless clearly stated or indicated otherwise, the descriptions regarding the tool caddy 110 of FIGS. 1-12 also apply to the tool caddy 110′.

In this embodiment, one or more of the tool organizers 114, 116 of the tool caddy 110′ comprises a respective insert 214, 216 encapsulated by sheet metal 414, 416. The inserts 214, 216 are generally configured for snugly holding tools received in the respective tool organizer 114, 116. In one example, at least one of the plurality of tool organizers 114, 116 comprises a sheet metal liner 414, 416 that encapsulates the corresponding insert. The tool holes in each tool organizer 114, 116 are formed in both the sheet metal liner and the insert. But in one or more embodiments, the tool holes formed in the insert 214, 216 have a smaller cross sectional dimension than a corresponding dimension of the same tool hole in the sheet metal liner. For example, a tool hole of a tool organizer has a first cross-sectional dimension, and a tool hole of the corresponding insert has a second cross-sectional dimension less than the first cross-sectional dimension. The smaller-sized tool holes in the insert are configured to securely (snugly) receive portions of the tools received therein. Suitably, the inserts may be formed from resiliently compressible material that engages the tools received in the tool holes with a slight compression fit. In an exemplary embodiment, the inserts are formed from foam machined to make the smaller sized tool holes.

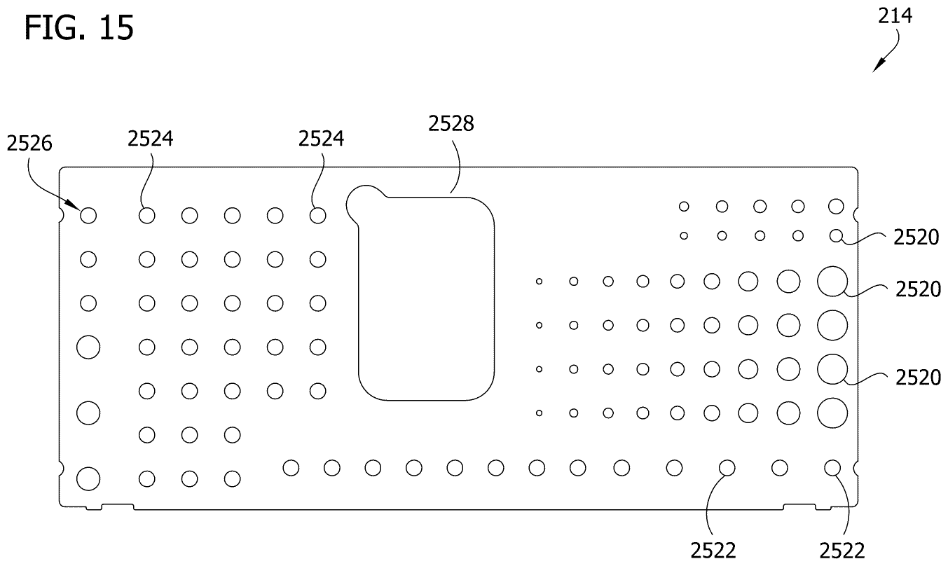

As shown in FIG. 15, the moveable organizer insert 214 comprises a plurality of tool holes 2520, 2522, 2524, 2526, and 2528 that are smaller than, and align with the plurality of tool holes formed in the sheet metal liner 414 (which, in an exemplary embodiment, have the same size shape and arrangement as tool holes 1520, 1522, 1524, 1526, and 1528 of tool plate 152 discussed above). As in the first embodiment, the bottom sheet metal of the tool organizer 114 can be solid (lacking any holes) so that the tools held by the tool organizer 114 do not protrude beyond the bottom plane of the movable tool organizer 114.

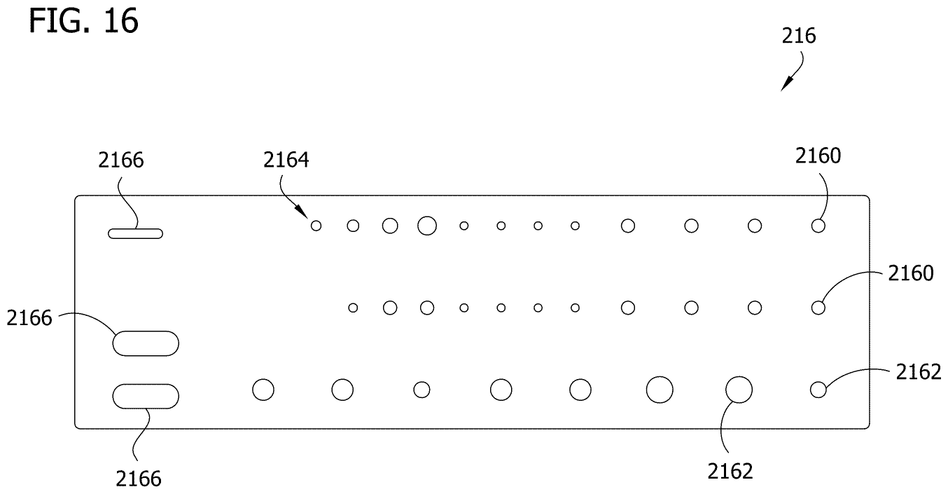

As shown in FIG. 16, the upper tool organizer insert 216 comprises a plurality of tool holes 2160, 2162, 2164, 2166 that are smaller than, and align with the plurality of tool holes formed in the sheet metal liner 416 (which, in an exemplary embodiment, have the same size shape and arrangement as tool holes 1160,1162, 1164, 1166 of the upper tool organizer 116). The upper tool organizer 215 has upper and lower sheet metal 316 defining tool holes of the same size, shape, and arrangement.

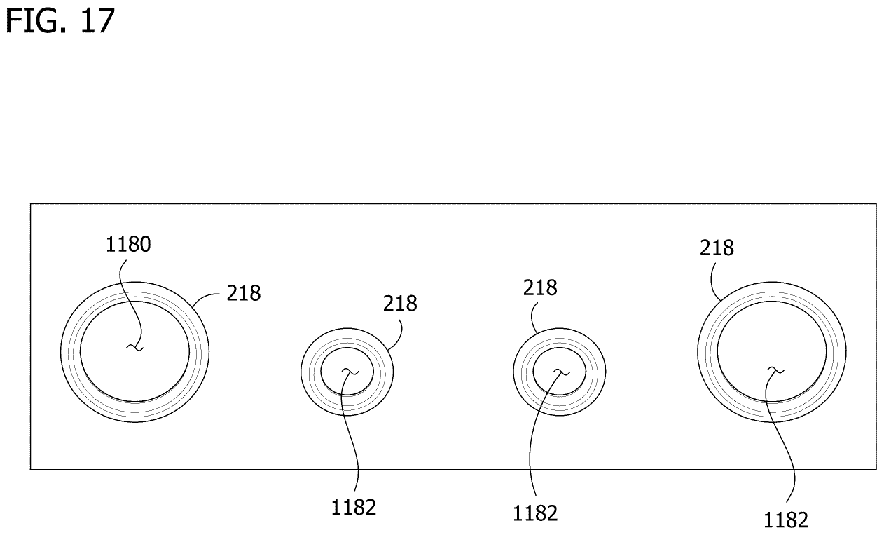

Referring now to FIGS. 14 and 17, in the illustrated embodiment, the drill/driver organizer 118 comprises a sheet metal top 418 that is formed from the same piece of sheet metal as the sheet metal liner 416 of the tool organizer 116. The drill/driver organizer 118 further comprises rubber grommets 218 that fit into a plurality of tool holes 1180, 1182 formed in the sheet metal top 418.

The tool caddy 110′ differs from the tool caddy 110 in how it mounts on the utility cart. The tool caddy 110′ comprises a removable base 200 which forms a part of the quick connect fastening system for releasably fastening the tool caddy 110′ to the cart without requiring any tightening of threaded fasteners. Referring back to FIG. 13, the removable base 200 is configured for attaching the tool caddy 110′ to the bottom B of the cart. The removable base 200 comprises a mounting plate 202, a catch 204, and a channel 206. In general, the mounting plate 202 is configured for securing the removable base 200 to the bottom B of the cart, and the catch 204 and channel 206 are configured for securing the tool caddy 110′ to the removable base.

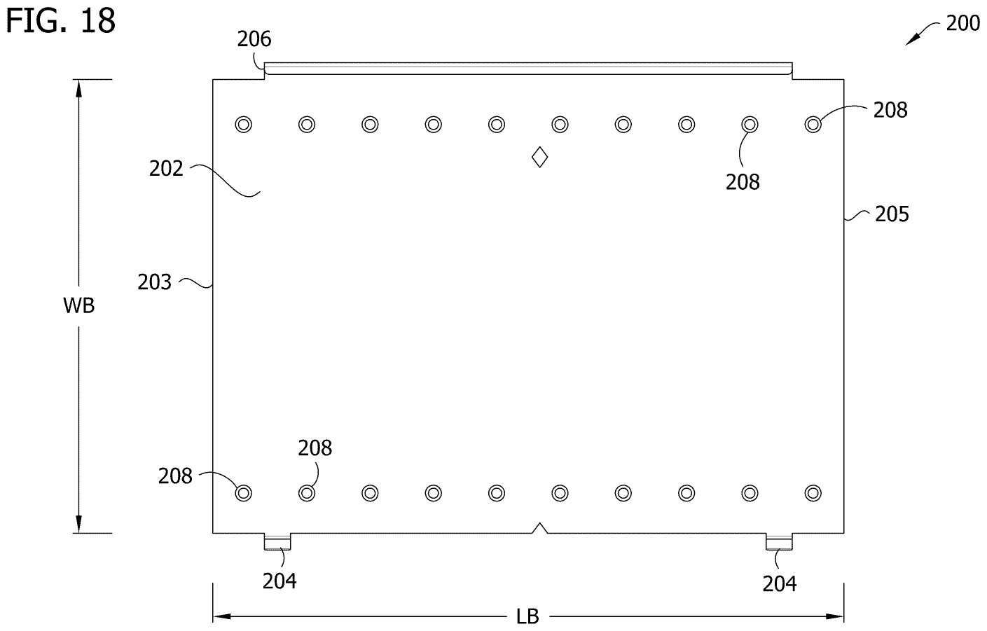

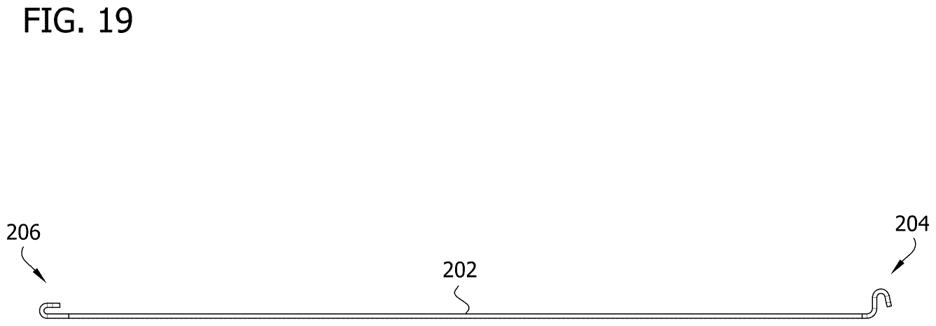

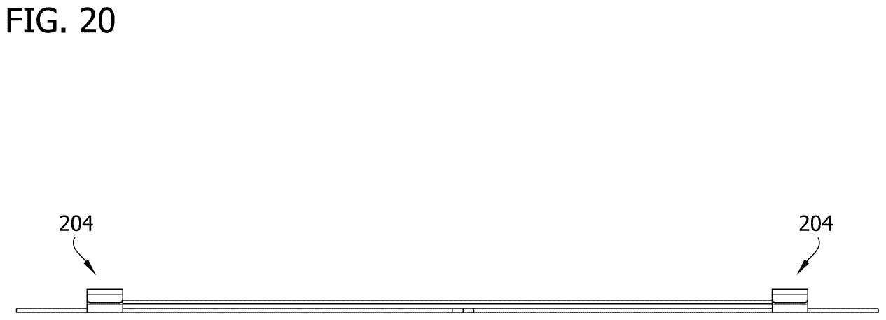

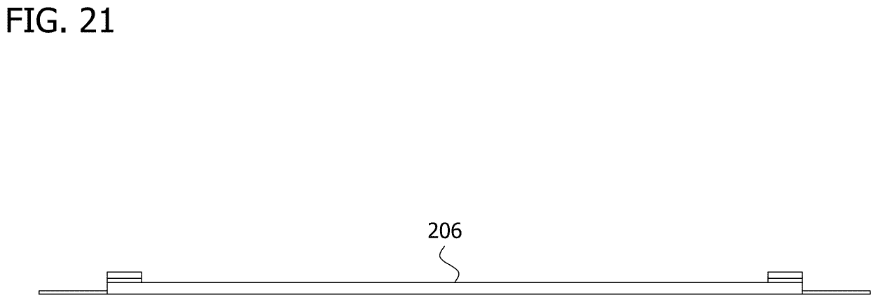

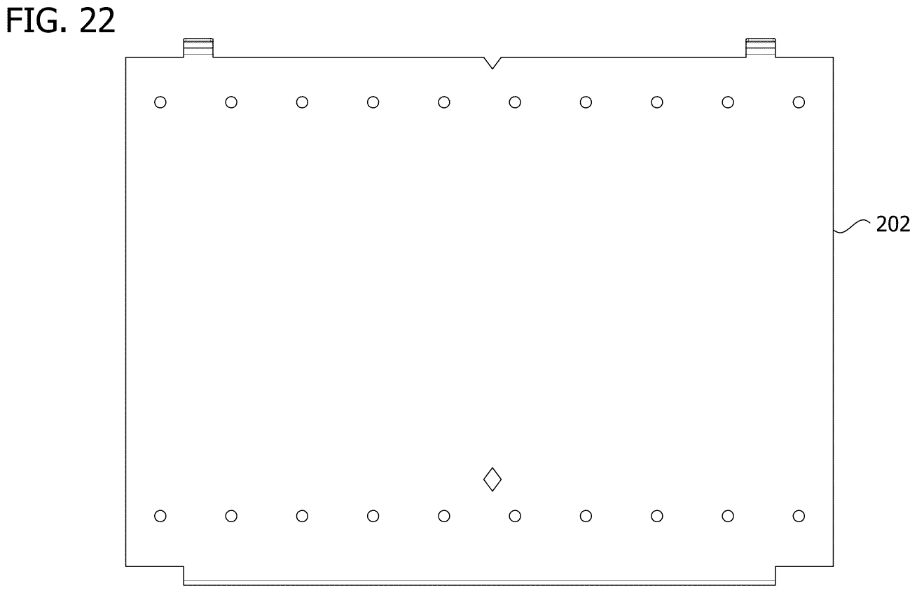

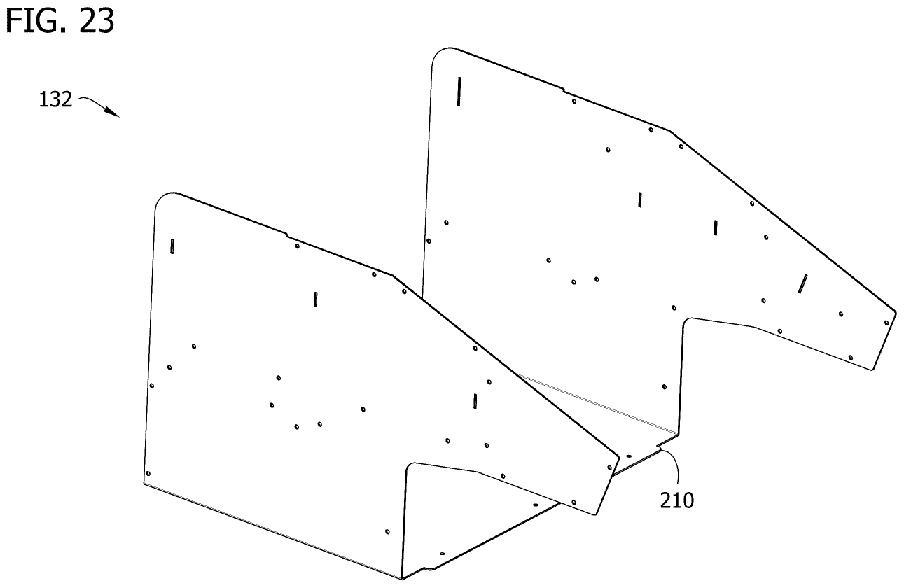

An exemplary embodiment of the removable base 200 is shown in FIGS. 18-22. The removable base 200 comprises a first end portion 203, and a second end portion 205 spaced apart by a length LB of the removable base. In use, the base length LB runs parallel to the tool caddy width W. The catch 204 and the channel 206 are spaced apart by a base width WB of the removable base 200, which runs parallel to the longitudinal axis LA of the tool caddy 110′ during use. In general, the removable base 200 is shaped and arranged to correspond with the bottom of the tool caddy 110′.

The mounting plate 202 defines one or more mounting holes 208 configured to receive one or more threaded fasteners 242 (e.g., a bolt and a nut) inserted through the tray of the cart for securing the removable base 200 to the cart. The mounting holes 208 are countersunk so that the heads of the threaded fasteners 242 sit below the top surface of the mounting plate 202 when secured to the cart. Further, there are a greater number of mounting holes 208 than threaded fasteners 242 (e.g., in one or more embodiments 2-4 threaded fasteners are used to secure the removable base 200 to the cart). This allows the user to select a subset of the mounting holes 208 in which to place the threaded fasteners 242 to avoid obstacles on the underside of the cart (e.g., injection molded reinforcement). In the illustrated embodiment, a first set of the mounting holes 208 is spaced apart along the length LB of the removable base 200 proximate the catch 204, and a second set of the mounting holes is spaced apart along the length of the removable base proximate the channel 206. In an exemplary embodiment, the quick connect fastening system comprises two threaded fasteners 242 installed through the first set of mounting holes 208 proximal the catch 204, and two threaded fasteners installed through the second set of mounting holes proximal the channel 206.

Each catch 204 is configured to engage with a releasable latch 140 of the quick connect fastening system of the tool caddy 110′. In the illustrated embodiment, the removable base 200 comprises two catches 204 spaced apart from one another along the length LB of the removable base. Each releasable latch 140 is configured to releasably latch with a catch 204 to secure the caddy body to the removable base 200.

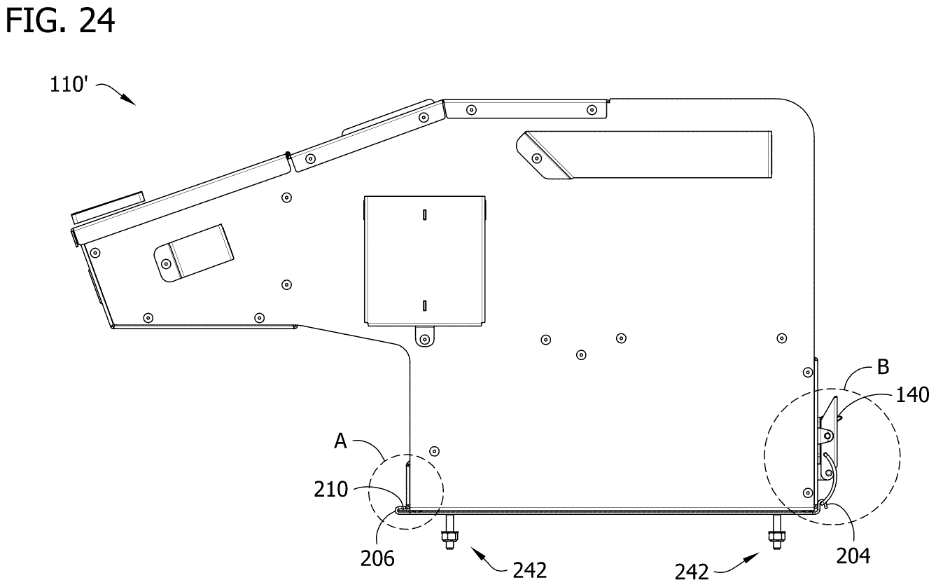

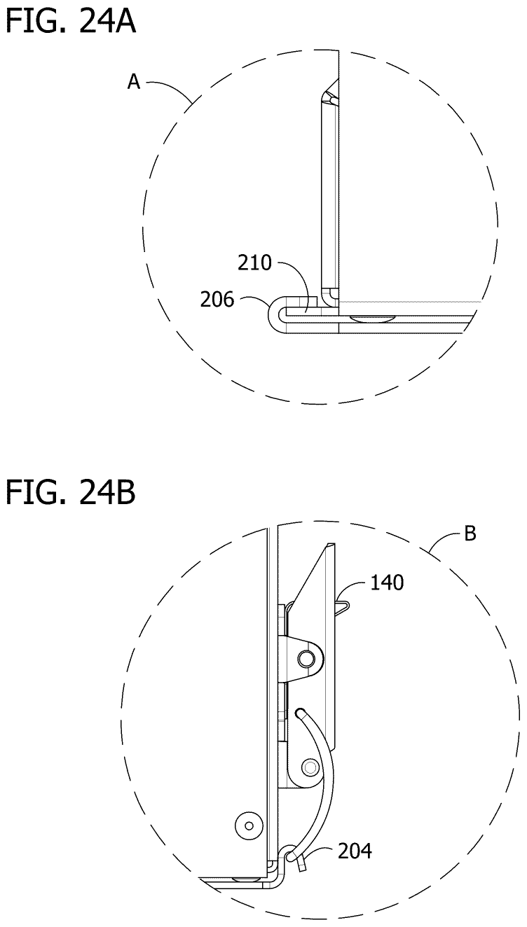

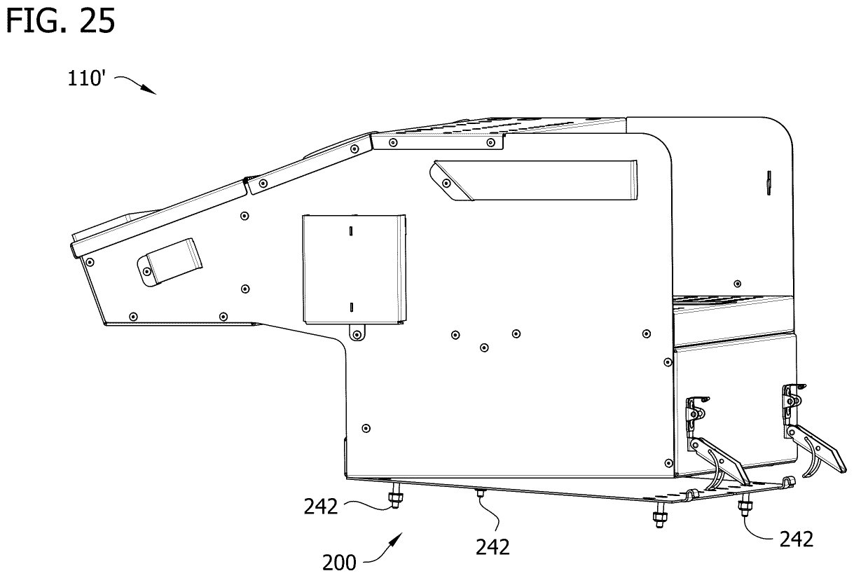

In this embodiment, the quick-connect fastening system of the tool caddy 110′ further comprises an attachment tab 210 formed on the bottom of the caddy body 112. FIG. 23 shows the attachment tab 210 formed as a part of the chassis 132 of the caddy body 112. The attachment tab 210 is configured to be received within the channel 206 of the removable base 200 for securing the tool caddy 110′ to the removable base, as shown in FIG. 24 and FIG. 24A. In an exemplary embodiment, the channel 206 and attachment tab 210 extend along the length LB of the removable base 200. FIG. 25 shows the removable base 200 in the process of being attached to the tool caddy 110′. As can be seen, the user initially places the attachment tab 210 into the channel 206 before pressing the opposite end of the caddy 110′ down so that the releasable latches 140 are positioned for latching with the catches 204

Referring back to FIG. 13, the quick-connect fastening system and removable base 200 of the tool caddy 110′ are shown when the caddy is secured to the base. As can be seen, the threaded fasteners 142 are inserted into holes formed in the bottom B of the cart tray T and through the mounting holes 208 of the mounting plate 202. As shown in FIG. 24B, each releasable latch 140 is latched with a catch 204. The attachment tab 210 is received within the channel 206 (FIG. 24A). To remove the tool caddy 110′ from the cart tray T, the user simply unlatches the releasable latches 140, tilts the tool caddy and slides the tool caddy in the inboard-of-cart longitudinal direction IC to remove the attachment tab 210 from the channel 206, and then lifts the tool caddy out of the tray T.

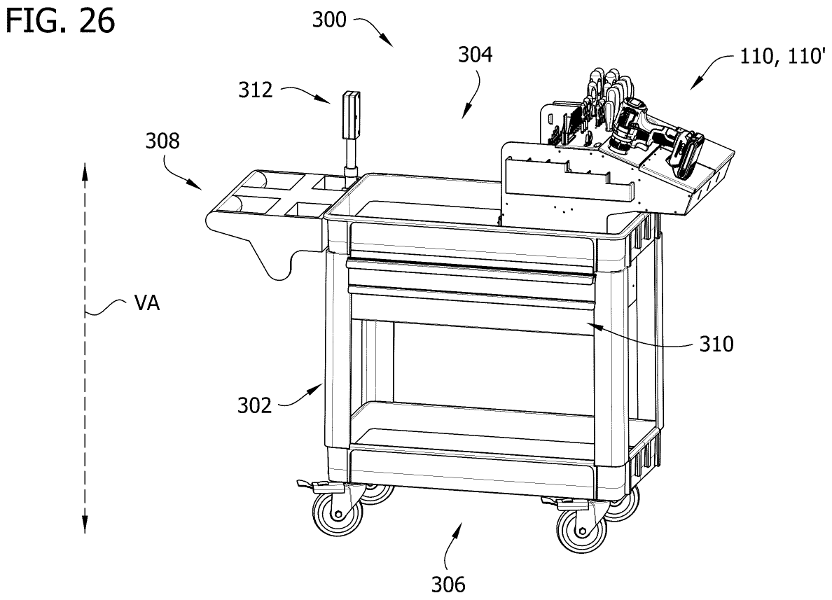

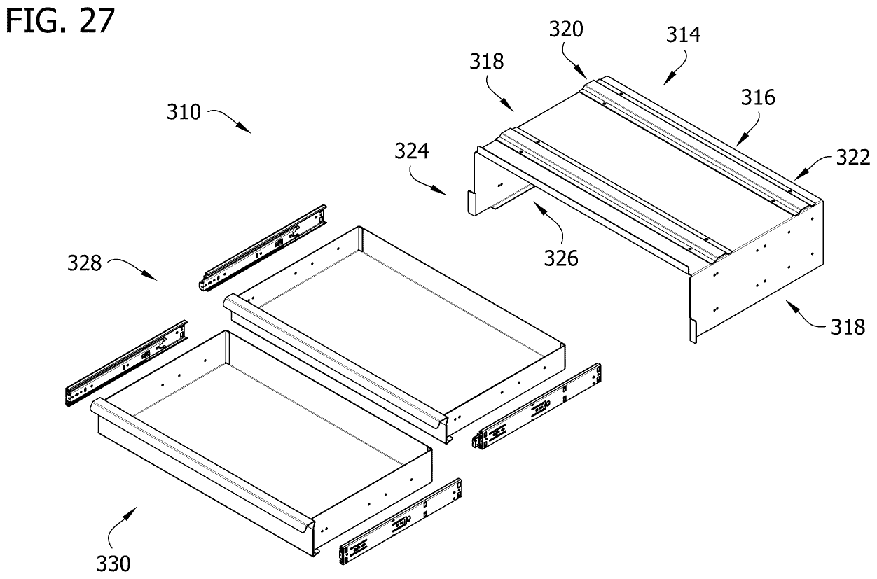

Referring now to FIG. 26, a tool cart configured for supporting tool organizing attachments such as either of the tool caddies 110, 110′ described above, is generally indicated at reference number 300. The tool cart 300 comprises a cart frame 302 having a cart top 304 and a cart bottom 306 spaced apart vertically from one another along a vertical axis VA of the tool cart. In the illustrated embodiment, the cart top 304 is configured for supporting the tool caddy 110, 110′, and the cart bottom 306 comprises a storage tray with wheels attached to a bottom thereof for transporting the cart. Moreover, the tool cart 300 comprises a handle portion 308 proximate the cart top 304. The handle portion 308 comprises a handle for a user to grip to transport the cart 300, and in the illustrated embodiment, the handle portion includes storage features for storing additional tools and components. In an exemplary embodiment, the tool cart 300 is configured to support at least one of a cart-mountable drawer assembly attachment 310 and a cart-mountable storey-pole attachment 312.

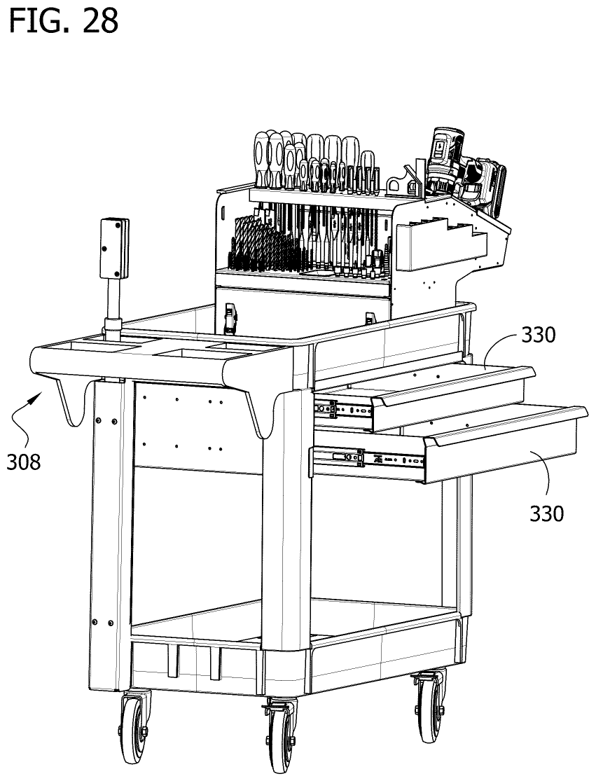

Exemplary embodiments of the cart-mountable drawer assembly attachment 310 are shown in FIGS. 27 and 28. Generally, the cart-mountable drawer assembly attachment 310 is mounted on the tool cart 300 to provide additional storage and organization. FIG. 27 shows an exploded perspective of the cart-mountable drawer assembly attachment 310 including a drawer case 314, and a storage assembly. The drawer case 314 is configured for mounting the cart-mountable drawer assembly attachment 310 to the cart 300 (e.g., on the underside of the top cart tray), and includes top 316 and side 318 portions defining an interior space. The top portion 316 comprises one or more mounting reinforcements 320, and one or more alignment holes 322 extending therethrough, configured for receiving one or more fastening elements such as ribs or extrusions on a lower surface of the cart top 304. Therefore, the alignment holes 322 are preferably positioned and arranged for alignment with reinforcement on the cart tray so that fasteners (e.g., screws) extended through the alignment holes engage and fasten into the reinforcement on the cart tray. In this way, the drawer case 314 mounts the drawer assembly attachment 310 on the cart 300 and more specifically mounts the drawer case 314 to the lower surface of the cart top 304. In the illustrated embodiment, the drawer case 314 further comprises aligning tabs 324 configured for aligning the drawer case for mounting to the cart 300, and support tabs 326 configured for supporting the storage assembly. In an exemplary embodiment, the storage assembly comprises two or more drawer slides 328 operably mounted to the side portions 318 of the drawer case 314, and disposed within the interior space. Moreover, the storage assembly comprises one or more drawers 330 configured for storing and organizing tools and components. The drawers 330 are operably mounted to the drawer slides 328 such that the drawers are moveable between closed and open positions.

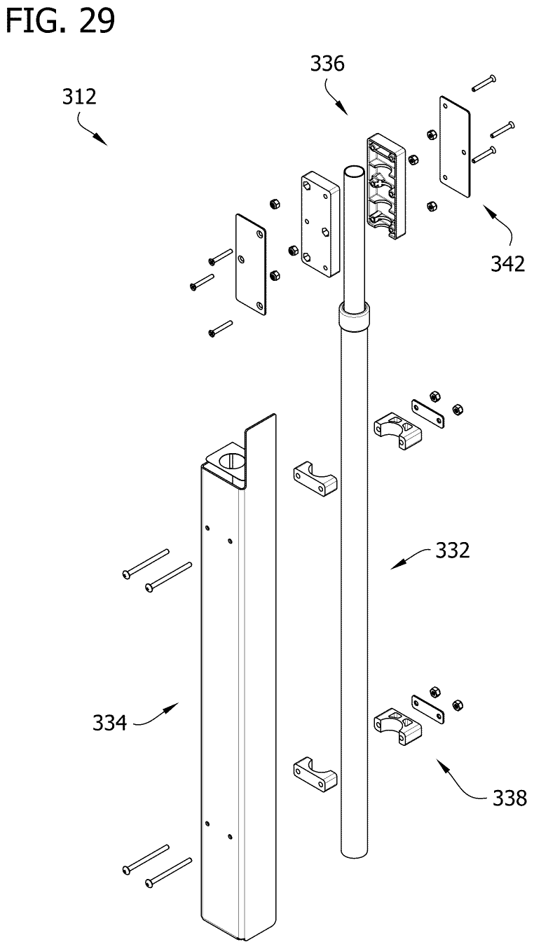

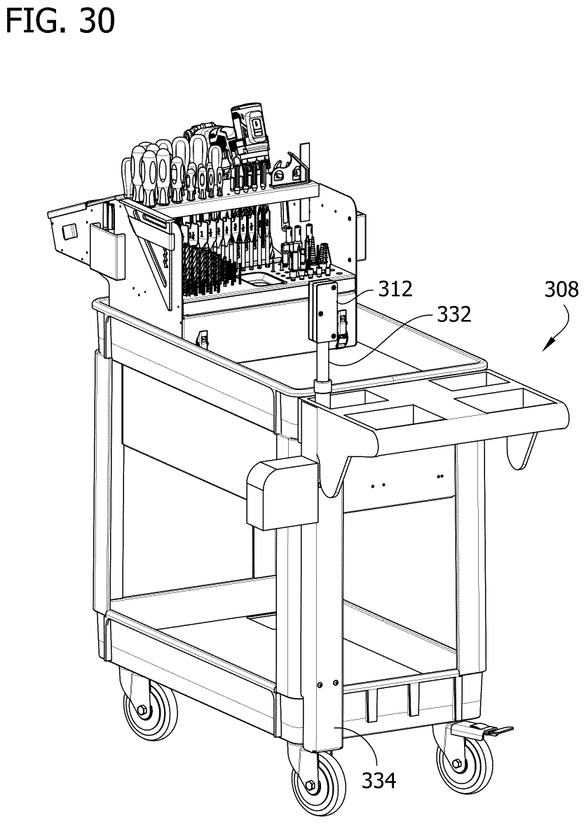

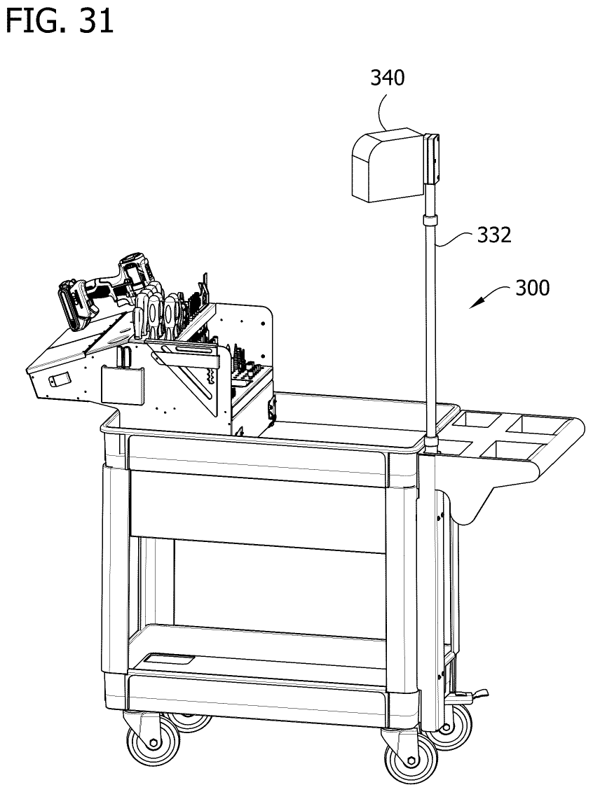

Exemplary embodiments of the cart-mountable story pole attachment 312 are shown in FIGS. 29-31. Generally, the cart-mountable story pole attachment 312 is configured for mounting a story pole to the cart 300 and for providing space for additional components. Advantageously, the cart-mountable story pole attachment 312 enables tools and components to be mounted on a story pole mounted to cart, instead of having to mount tools and components on separate structures such as a tripod. Broadly, the cart-mountable story pole attachment 312 comprises an extension pole 332, a cart mount 334, and a magnetic attachment 336. The extension pole 332 comprises top and bottom ends. The top end is configured to receive a magnetic attachment 336 for attaching tools or components such as a laser or a cup holder thereto. The bottom end is configured to be received within the cart mount 334 for securing the extension pole 332 to the cart 300. The extension pole 332 is adjustable between a retracted position FIG. 30 and an extended position FIG. 31, to provide an adjustable height of components and tools attached to the magnetic attachment. In an exemplary embodiment, the story pole comprises a telescoping pole.

The cart mount 334 is configured for removably mounting the cart-mountable story pole attachment 312 to the tool cart 300, and for providing housing for the story pole. In an exemplary embodiment, the cart mount 334 comprises magnetic properties for attaching tools and components thereto. In the illustrated embodiment, the cart mount 334 comprises a magnetic (e.g., ferromagnetic material such as ferrous steel) pole housing and one or more pole clamps 338 configured for securing the extension pole 332 within the magnetic pole housing. Additionally, the cart mount 334 may include a stop (not shown) for preventing the story pole from protruding through a bottom portion of the cart mount. In the illustrated embodiment, the cart mount 334 is mounted to the cart 300 proximate the handle portion 308 of the cart.

As explained briefly above, the magnetic attachment 336 is configured for attaching tools or components thereto, and is operably secured to the story pole. In the illustrated embodiment, the magnetic attachment includes a laser holder 340 with a magnetic backer 342 (e.g., a steel plate).

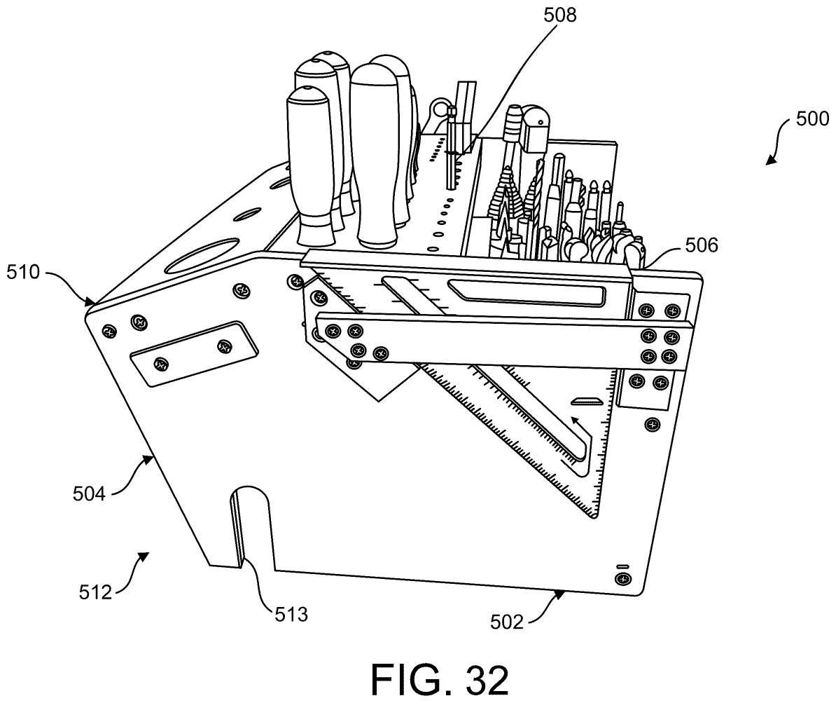

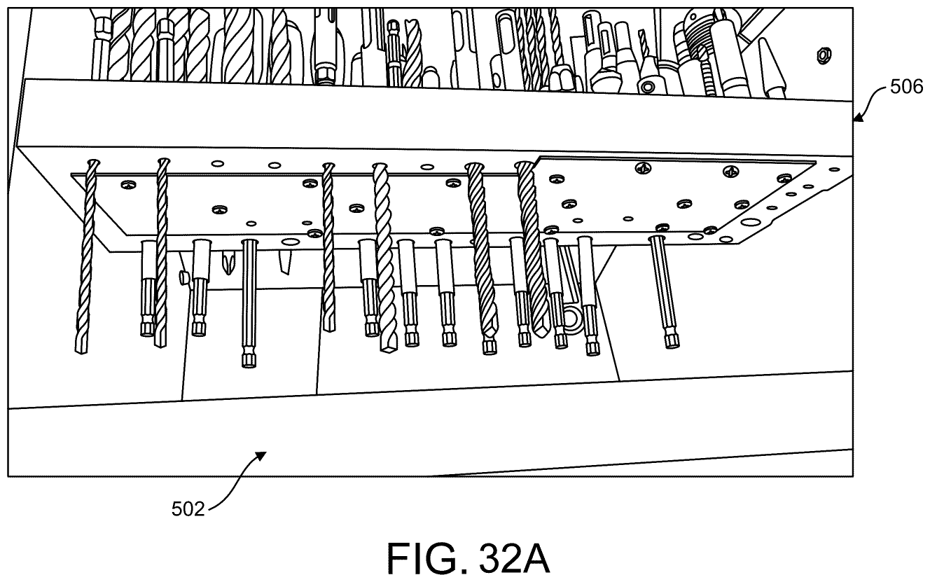

Referring now to FIG. 32 a different tool caddy, which was created by an inventor and used exclusively for a private contracting business for the last 20+years, is generally indicated by reference number 500. The tool caddy 500 has never been described in a printed publication or offered for sale in any respect. However, over the last 20+years it has been used by employees of the private contracting business on jobsites to hold tools of the trade.

The tool caddy 500 includes a caddy body 502 that has an overhang portion 504 and is attachable to a cart. The tool caddy 500 further includes a plurality of tool organizers 506, 508, and 510, however the tool caddy 500 differs in many respects from the tool caddies 110 and 110′. For example, the caddy body 502 lacks the quick connect fastening system for cart fastening of the tool caddy 110. Instead the caddy body has a lip 512 defining a slot 513 that loosely sits over a cart rim. Securing the caddy 500 to a cart requires screwing it down. The overhang portion 504 of the caddy 500 does not include a bin for storing tools or a lid on the bin that underlies grip and/or battery portions of tools. The plurality of tool organizers 506, 508 and 510 are all fixed to the caddy body 502 and lack the capability to move in relation to the caddy body between open and closed positions. FIG. 32A shows tool organizer 506 fixed to caddy body 502 with no moving capabilities. Furthermore, tool organizer 506 does not include a closed bottom that prevents the tools held by the tool organizer 506 from extending downward further into the tool caddy body, thereby making the space below the tool organizer 506 inaccessible and unusable.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above products without departing from the scope of the invention, it is intended that all matter contained in the above description and shown in the accompanying drawings shall be interpreted as illustrative and not in a limiting sense.

1. A tool caddy for organizing a plurality of tools on a cart, the tool caddy comprising:
a caddy body comprising a cart-top portion and an overhang portion, the caddy body configured to be supported on the cart such that the cart-top portion is above the cart and the overhang portion overhangs the cart,
a plurality of tool organizers supported on the caddy body, each tool organizer comprising a plate defining a plurality of tool holes configured to receive portions of tools for holding the tools on the respective plate; and
a bin supported on the overhang portion of the caddy body.

2. The tool caddy of claim 1, further comprising a lid over the bin.

3. The tool caddy of claim 2, wherein one of the plurality of tool organizers is supported on the overhang portion between the lid and the cart-top portion of the caddy body.

4. The tool caddy of claim 3, wherein said one of the plurality of tool organizers comprises a drill/driver organizer, the drill/driver organizer comprising tool holes sized and arranged for receiving chuck portions of cordless drills or drivers, and wherein the lid is configured to underlie at least one of grip portions and battery portions of cordless drills or drivers received in the tool holes of the drill/driver organizer.

5. The tool caddy of claim 4, wherein the lid and the drill/driver organizer are generally coplanar, extending in a plane sloping downward in an outboard-of-cart direction.

6. (canceled)

7. (canceled)

8. The tool caddy of claim 1, wherein one of the plurality of tool organizers comprises a drill/driver organizer, the drill/driver organizer comprising first and second holes sized and arranged for receiving chuck portions of cordless drills and first and second driver holes sized and arranged for receiving chuck portions of cordless drivers, the driver holes being smaller than the drill holes.

9. The tool caddy of claim 1, wherein at least one of the plurality of tool organizers comprises sheet metal encapsulating a foam insert, wherein each of the respective plurality of tool holes includes a hole portion formed in the sheet metal having a first cross-sectional dimension and a hole portion formed in the foam insert having a second cross-sectional dimension less than the first cross-sectional dimension.

10. A tool caddy for organizing a plurality of tools on a cart, the tool caddy comprising:
a caddy body configured to be supported on the cart, the caddy body having a bottom, a top, and a height extending from the bottom to the top, the caddy body further having an inner end an outer end spaced apart along a longitudinal axis, the caddy body defining a lower storage compartment having a top;
a plurality of tool organizers supported on the caddy body, each tool organizer comprising a plate defining a plurality of tool holes configured to receive portions of tools for holding the tools on the respective plate, one of the plurality of tool organizers comprising a moveable organizer; and
wherein the moveable organizer is operably connected to the caddy body such that moveable organizer is moveable in relation to the caddy body between a closed position in which the moveable organizer covers the top of the lower storage compartment and an open position in which the moveable organizer uncovers the top of the lower storage compartment.

11. The tool caddy of claim 10, wherein the moveable organizer has an enclosed bottom.

12. (canceled)

13. The tool caddy of claim 11, wherein the caddy body comprises inner and outer end panels defining inner and outer ends of the lower storage compartment, respectively, each of the inner and outer end panels extending height-wise from the bottom end of the caddy body to the moveable organizer.

14. The tool caddy of claim 13, wherein the outer end panel slopes downward in an outboard-of-cart direction along the longitudinal axis.

15. The tool caddy of claim 14, wherein the plurality of tool organizers further comprises an upper tool organizer at least partially above the outer end panel, and wherein the upper tool organizer has a top and a bottom and one or more of the tool openings of the upper tool organizer extend from the top through the bottom of the upper tool organizer.

16. (canceled)

17. The tool caddy of claim 15, wherein the upper tool organizer has an inner end and an outer end and wherein the tool openings of the upper tool organizer include of an inner row of tool openings adjacent the inner end of the upper tool organizer and an outer row of tool openings adjacent the outer end of the upper tool organizer, the tool openings in the outer row of tool openings being on average larger than the tool openings of the inner row of tool openings.

18. The tool caddy of claim 15, wherein the upper tool organizer is located above the moveable tool organizer along the height of the caddy body and wherein the upper tool organizer is offset from the moveable tool organizer along the longitudinal axis in an outboard-of-cart direction.

19. A tool caddy for organizing a plurality of tools on a cart, the tool caddy comprising:
a caddy body,
a plurality of tool organizers supported on the caddy body, each tool organizer comprising a plate defining a plurality of tool holes configured to receive portions of tools for holding the tools on the respective plate; and
a lower storage compartment having a selectively closable top opening and configured for receiving loose supplies through the selectively closeable top opening;
wherein one of the plurality of tool organizers is a lower tool organizer, the lower tool organizer having an enclosed bottom, the lower storage compartment and the lower tool organizer being selectively moveable in relation to one another between a closed position in which the enclosed bottom covers the selectively closable top opening to close the selectively closable top opening and an open position in which the selectively closable top opening is uncovered;
wherein at least one other of the plurality of tool organizers has an unenclosed bottom such that tools can be inserted through the respective tool openings across the unenclosed bottom.

20. (canceled)

21. A tool caddy for organizing a plurality of tools on a cart, the tool caddy comprising:
a caddy body configured to be supported on the cart;
a plurality of tool organizers supported on the caddy body, each tool organizer comprising a plate defining a plurality of tool holes configured to receive portions of tools for holding the tools on the respective plate; and
a quick-connect fastening system configured to releasably fasten the tool caddy to the cart without tightening threaded fasteners.

22. The tool caddy of claim 21, wherein the caddy body has a longitudinal axis, the quick-connect fastening system comprising a stud and a releasable latch secured to the caddy body at spaced apart locations along the longitudinal axis, the stud configured to be inserted into a stud opening formed in a rim of a top tray of the cart, the releasable latch configured to releasably latch with a catch secured to a bottom of the top tray of the cart.

23. (canceled)

24. The tool caddy of claim 21, wherein the quick-connect fastening system comprises:
a removable base comprising a catch and a mounting plate, the mounting plate defining one or more mounting holes configured to receive one or more fasteners inserted through a bottom of a top tray of the cart for securing the removable base to the cart; and
a releasable latch secured to the caddy body and configured to releasably latch with the catch to secure the caddy body to the removable base.

25. (canceled)

26. The tool caddy of claim 21, wherein the quick-connect fastening system comprises:
a removable base comprising a channel and a mounting plate, the mounting plate defining one or more mounting holes configured to receive one or more fasteners inserted through a bottom of a top tray of the cart for securing the removable base to the cart; and
an attachment tab secured to the caddy body and configured to be received within the channel to secure the caddy body to the removable base.

27. The tool caddy of claim 21, wherein the quick-connect fastening system comprises a releasable latch secured to the caddy body and a catch secured to a top surface of the cart, the releasable latch configured to releasably latch with the catch to secure the caddy body in place on the cart.

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)
